(19) United States
(12) Patent Application Publication
(10) Pub. No.: US 2017/0284809 A1
(43) Pub. Date: Oct. 5, 2017

(54) SEA AREA INFORMATION GENERATION METHOD AND SEA AREA INFORMATION GENERATION DEVICE

(71) Applicant: FUJITSU LIMITED, Kawasaki-shi (JP)

(72) Inventor: Kazunari TANAKA, Kawasaki (JP)

(73) Assignee: FUJITSU LIMITED, Kawasaki-shi (JP)

(21) Appl. No.: 15/443,063

(22) Filed: Feb. 27, 2017

(30) Foreign Application Priority Data
Mar. 31, 2016 (JP) 2016-073109

(51) Int. Cl. G01C 21/20; B63B 49/00; G08G 3/02

(52) U.S. Cl. CPC G01C 21/203; G08G 3/02; B63B 49/00; B63B 2213/00; B63B 2732/00

(57) ABSTRACT

A non-transitory computer-readable recording medium stores therein a generation program that causes a computer to execute a process. The process includes acquiring positional information including positions of a plurality of ships at a plurality of timings; acquiring, or generating from the positional information of the plurality of ships, sailing route information; and generating closest distance information for each sea area corresponding to positions of closest approach of two ships, from the positional information and the sailing route information, the closest distance information including a statistical quantity of a distance of closest approach between the two ships, the statistical quantity of a distance of closest approach being calculated based on encountering relationship for directions of the two ships and whether or not ship tracks of the two ships are along a sailing route in the sea area.

### CROSS-REFERENCE TO RELATED APPLICATIONS

This application is based upon and claims the benefit of priority of the prior Japanese Patent Application No. 2016-073109, filed on Mar. 31, 2016, the entire contents of which are incorporated herein by reference.

### FIELD

The embodiments discussed herein are related to a sea area information generation method and a sea area information generation device.

### BACKGROUND

In general, as a size of a ship is increased, a sudden course change or stop thereof becomes more difficult. Accordingly, a technique of avoiding collision between ships has been proposed conventionally. For example, a ship includes means for acquiring information of another ship, such as an Automatic Identification System (AIS) or a radar. Determination of a risk of collision is executed by using such information of another ship. For example, abnormal closeness is determined in a case where a distance between ships is less than a predetermined reference. Such a reference may be a certain distance, or may be, for example, that of an ellipse that is long in a traveling direction of a ship by taking the traveling direction into consideration.

Japanese Laid-open Patent Publication No. 2015-186956

Japanese Laid-open Patent Publication No. 06-325300

However, a factor that is to be taken into consideration for safety of a ship is not only a relationship between ships but also may be a geographical factor that acts thereon, and as determination of abnormal closeness is executed by only a relationship between ships, there is a possibility of erroneously detecting approach with a low risk of collision as abnormal closeness.

### SUMMARY

According to an aspect of an embodiment, a non-transitory computer-readable recording medium stores therein a generation program that causes a computer to execute a process. The process includes acquiring positional information including positions of a plurality of ships at a plurality of timings; acquiring, or generating from the positional information, sailing route information of the plurality of ships; and generating closest distance information for each sea area corresponding to positions of closest approach of two ships, from the positional information and the sailing route information, the closest distance information including a statistical quantity of a distance of closest approach between the two ships, the statistical quantity of a distance of closest approach being calculated based on encountering relationship for directions of the two ships and whether or not ship tracks of the two ships are along a sailing route in the sea area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a general configuration of a support system;

FIG. 2 is a diagram illustrating a general configuration of a sea area information generation device;

FIG. 3 is a diagram illustrating an example of a data configuration of closest approach information;

FIG. 4A, FIG. 4B, and FIG. 4C are diagrams illustrating an encounter relationship;

FIG. 5 is a diagram illustrating an angle between ships;

FIG. 6 is a diagram illustrating a case where two ships are positioned in different sea areas;

FIG. 7 is a diagram illustrating an example of a result of counting of the number of occurrences for each sear area;

FIG. 8 is a diagram illustrating ship tracks of two ships that travel along a sailing route thereof;

FIG. 9A is a diagram illustrating a tendency of sailing of a ship;

FIG. 9B is a diagram illustrating a tendency of sailing of a ship;

FIG. 10 is a diagram illustrating an example of a traveling direction;

FIG. 11 is a diagram illustrating an example of a difference between a ship track of a ship and a direction of a sailing route thereof;

FIG. 12 is a diagram illustrating an example of an average of distances of closest approach;

FIG. 13 is a flowchart illustrating an example of steps of a sea area information generation process;

FIG. 14 is a flowchart illustrating an example of steps of a approach determination process; and

FIG. 15 is a diagram illustrating a computer that executes a sea area information generation program.

### DESCRIPTION OF EMBODIMENTS

Preferred embodiments of the present invention will be explained with reference to accompanying drawings. This invention is not limited by these embodiments. It is possible to combine respective embodiments appropriately as long as process contents thereof are consistent with one another. Hereinafter, a case where the invention is applied to a support system that supports sailing of a ship will be described as an example.

System Configuration

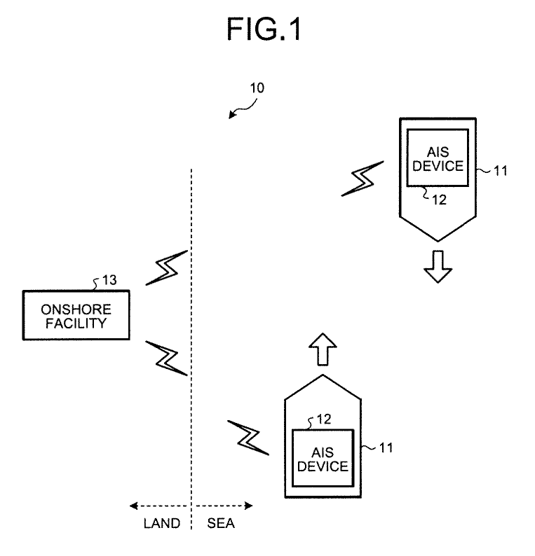

First, an example of a support system 10 according to a first embodiment will be described. FIG. 1 is a diagram illustrating an example of a general configuration of a support system. The support system 10 is a system that supports sailing of a ship.

FIG. 1 illustrates two ships 11 and an onshore facility 13. The ship 11 is mounted with an AIS device 12. For example, a particular ship is obligated to mount the AIS device 12 according to a law or the like. Such a particular ship corresponds to any ship of 300 gross tons or more that engages in an international voyage, any passenger ship that engages in an international voyage, or any ship of 500 gross tons or more that does not engage in an international voyage. The AIS device 12 may also be mounted on a ship other than such a particular ship.

The AIS device 12 periodically transmits AIS information that includes a variety of information on the ship 11 mounted therewith through wireless communication. AIS information includes, for example, information such as a position represented by latitude and longitude, a ship name, a point of time, a direction of a bow of the ship 11, an identification code of the ship 11 such as a Maritime Mobile Service Identity (MMSI) number, or a length or a width of the ship 11. AIS information is receivable by the other ship 11 or the onshore facility 13. The other ship 11 or the onshore facility 13 can catch a variety of information such as a position of the ship 11, a ship name, a point of time, a direction of a bow of the ship 11, an identification code of the ship 11, or a length or a width of the ship 11, based on received AIS information.

The onshore facility 13 is, for example, a facility that executes control of sailing, such as a vessel traffic service center or a port traffic control office in the Japan Coast Guard. The onshore facility 13 catches a position of each ship 11 based on AIS information received from each ship 11, information detected by a radar, or the like, and provides a variety of information on sea traffic to each ship 11.

Configuration of Sea Area Information Generation Device

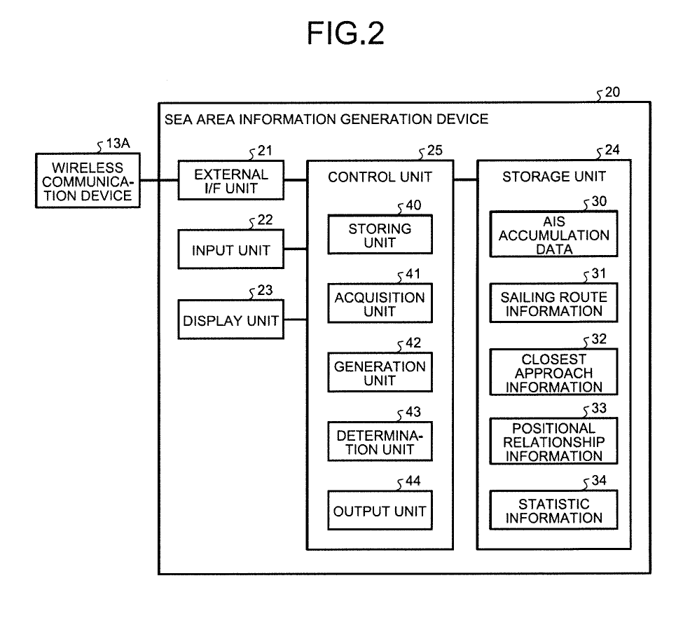

Next, a configuration of a sea area information generation device 20 according to the first embodiment will be described. FIG. 2 is a diagram illustrating a general configuration of a sea area information generation device. The sea area information generation device 20 is a device that is provided for the onshore facility 13 and supports sailing of a ship. For example, the sea area information generation device 20 is a computer such as a server computer. The sea area information generation device 20 may be provided as a single computer or may be provided as a plurality of computers. In the present embodiment, a case where the sea area information generation device 20 is a single computer will be described as an example.

The sea area information generation device 20 includes an external interface (I/F) unit 21, an input unit 22, a display unit 23, a storage unit 24, and a control unit 25.

The external I/F unit 21 is, for example, an interface that transmits to or receives from another device, a variety of information. The external I/F unit 21 is capable of wireless communication with each ship 11 through a wireless communication device 13A such as an antenna provided for the onshore facility 13, and transmits to or receives from each ship 11, a variety of information. For example, the external I/F unit 21 receives AIS information from each ship 11 through the wireless communication device 13A.

The input unit 22 is an input device that inputs a variety of information. For the input unit 22, an input device is provided that accepts input of an operation, such as a mouse or a keyboard. The input unit 22 accepts input of a variety of information. For example, the input unit 22 accepts input of an operation for instructing starts of a variety of processes. The input unit 22 inputs operation information that indicates a content of an accepted operation to the control unit 25.

The display unit 23 is a display device that displays a variety of information. For the display unit 23, a display device such as a Liquid Crystal Display (LCD) or a Cathode Ray Tube (CRT) is provided. The display unit 23 displays a variety of information. For example, the display unit 23 displays a variety of screens such as an operation screen.

The storage unit 24 is a storage device such as a hard disk, a Solid State Drive (SSD), or an optical disk. The storage unit 24 may be a data rewritable semiconductor memory such as a Random Access Memory (RAM), a flash memory, or a Non-Volatile Static Random Access Memory (NVSRAM).

The storage unit 24 stores an Operating System (OS) and a variety of programs that are executed by the control unit 25. For example, the storage unit 24 stores a program for executing a sea area information generation process or an approach determination process as described later. The storage unit 24 further stores a variety of data that are used for a program that is executed by the control unit 25. For example, the storage unit 24 stores AIS accumulation data 30, sailing route information 31, closest approach information 32, positional relationship information 33, and statistic information 34.

The AIS accumulation data 30 are data provided by accumulating AIS information received from each ship 11.

The sailing route information 31 is data including information on a sailing route that exists in a target range that is a target for control of sailing for the onshore facility 13. For example, the sailing route information 31 includes information of a position of a boundary of a region of a sailing route that exists in a target range, and in a case where a direction of a sailing route is set, information of the direction. Such a sailing route may be clearly specified on a chart or the like or may be empirically determined without being clearly specified on a chart or the like. For example, in a case where a rate of a direction of a sea track of a ship that passes through a specific region on a sea area is greater than or equal to a predetermined one (for example 70%), such a specific region may be regarded as a sailing route and included in the sailing route information 31. Herein, such a ship track is a trajectory of a position of a ship.

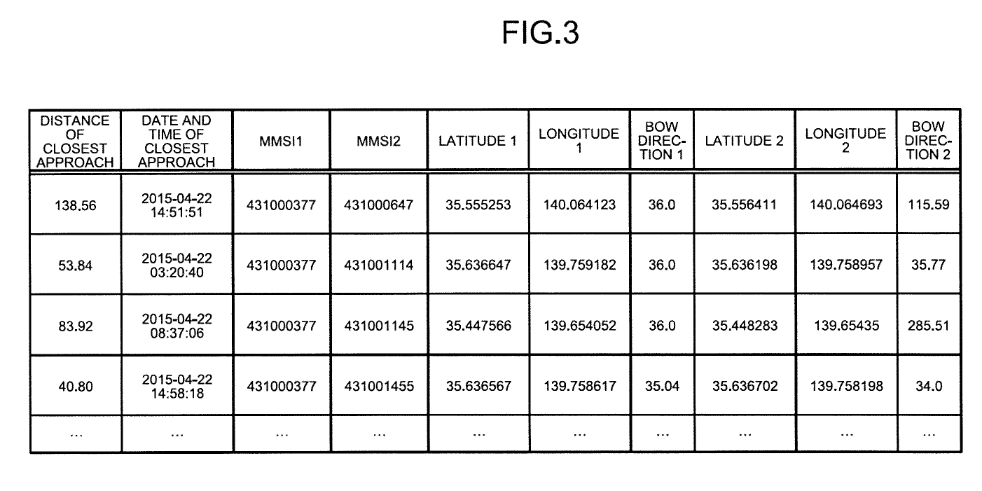

The closest approach information 32 is data including a distance of closest approach between two ships obtained from the AIS accumulation data 30. FIG. 3 is a diagram illustrating an example of a data configuration of closest approach information. As illustrated in FIG. 3, the closest approach information 32 includes items such as a “DISTANCE OF CLOSEST APPROACH”, a “DATE AND TIME OF CLOSEST APPROACH”, “MMSI 1”, “MMSI 2”, “LATITUDE 1”, “LONGITUDE 1”, “BOW DIRECTION 1”, “LATITUDE 2”, “LONGITUDE 2”, and “BOW DIRECTION 2”. Each item of the closest approach information 32 as illustrated in FIG. 3 is an example and another item may be included therein.

An item of distance of closest approach is an area for storing a distance of closest approach between two ships. An item of date and time of closest approach is an area for storing a date and time when two ships are provided at a distance of closest approach. An item of MMSI 1 is an area for storing an MMSI number of one ship among two ships. An item of MMSI 2 is an area for storing an MMSI number of the other ship among the two ships. Items of latitude 1 and longitude 1 are areas for storing latitude and longitude of a position where one ship is provided at a distance of closest approach. An item of bow direction 1 is an area for storing a bow direction at a position where one ship is provided at a distance of closest approach. Such a bow direction indicates an angular direction that is clockwise with respect to a northern direction as a reference orientation. Items of latitude 2 and longitude 2 are areas for storing latitude and longitude of a position where the other ship is provided at a distance of closest approach. An item of bow direction 2 is an area for storing a bow direction at a position where the other ship is provided at a distance of closest approach.

For example, a case is illustrated where two ships are provided at closest approach at 2015-04-22 14:51:51 and a distance of closest approach therebetween is 138.56 m. Among the two ships, one ship is illustrated in such a manner that an MMSI number is “431000377”, latitude and longitude of a position corresponding to a distance of closest approach are “35.555253” and “140.064123”, respectively, and a bow direction is “36.0”. Among the two ships, the other ship is illustrated in such a manner that an MMSI number is “431000647”, latitude and longitude of a position corresponding to a distance of closest approach are “35.556411” and “140.064693”, respectively, and a bow direction is “115.59”.

By returning to FIG. 2, the positional relationship information 33 is data including information on a positional relationship between ships that are provided at a distance of closest approach, for each sea area provided by dividing a target range that is a target for control of sailing for the onshore facility 13.

Herein, a positional relationship between ships will be described. In the present embodiment, a positional relationship between ships is classified into three patterns of an encounter relationship that are a facing relationship where two ships face one another, a following or passing relationship where one ship follows the other ship, and a crossing relationship where one ship crosses in front of the other ship.

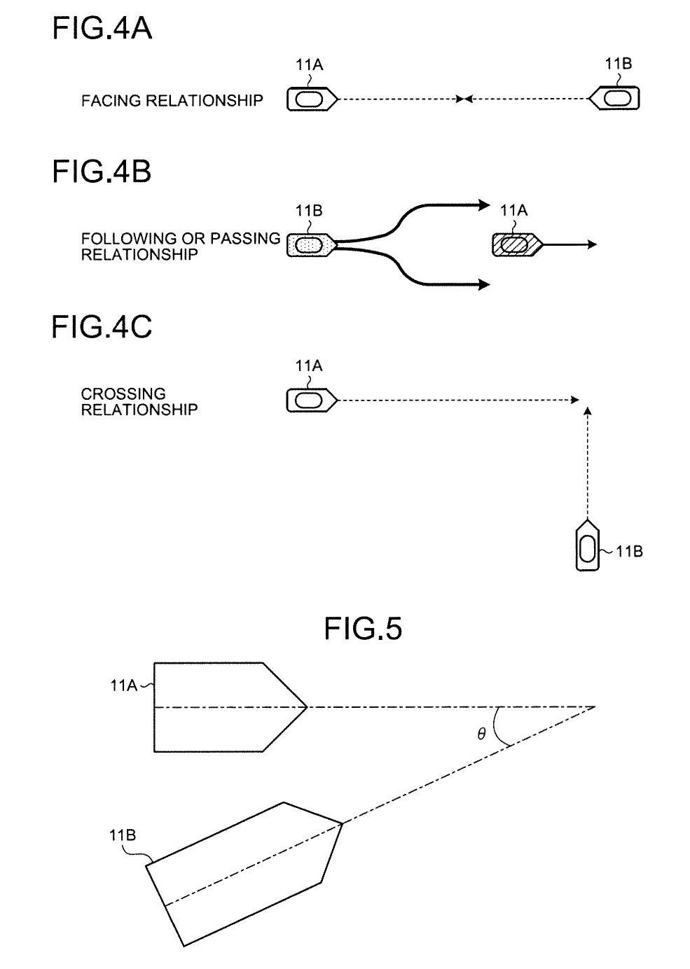

FIG. 4A, FIG. 4B, and FIG. 4C are diagrams illustrating an encounter relationship. FIG. 4A illustrates an example of a facing relationship where two ships 11A and 11B face one another. FIG. 4B illustrates an example of a following or passing relationship where a ship 11B follows a ship 11A. FIG. 4C illustrates an example of a crossing relationship where a ship 11B crosses in front of a ship 11A.

The positional relationship information 33 includes the number of occurrences of each pattern of an encounter relationship for each sea area provided by dividing a target range.

The statistic information 34 is data including closest distance information for each sea area corresponding to positions of closest approach of two ships. For example, the statistic information 34 is data including information on a statistic of a distance of closest approach for determining approach with a high risk of collision, for each sea area provided by dividing a target range.

By returning to FIG. 2, the control unit 25 is a device that controls the sea area information generation device 20. For the control unit 25, an electronic circuit such as a Central Processing Unit (CPU) or a Micro Processing Unit (MPU) or an integrated circuit such as an Application Specific Integrated Circuit (ASIC) or a Field Programmable Gate Array (FPGA) can be employed. The control unit 25 includes an internal memory for storing a program that defines steps of a variety of processes, and control data, and thereby, executes the variety of processes. The control unit 25 operates a variety of programs, and thereby, functions as a variety of processing units. For example, the control unit 25 includes a storing unit 40, an acquisition unit 41, a generation unit 42, a determination unit 43, and an output unit 44.

The storing unit 40 stores AIS information received from each ship 11 through the wireless communication device 13A as the AIS accumulation data 30.

The acquisition unit 41 acquires a variety of information. For example, the acquisition unit 41 acquires the sailing route information 31 and positional information including positions of a plurality of ships at a plurality of timings. For example, the acquisition unit 41 acquires, with reference to the sailing route information 31, information of a position of a boundary of a sailing route that exists in a target range that is a target for control of sailing for the onshore facility 13, and in a case where a direction of a sailing route is set, information of the direction. The acquisition unit 41 also acquires positional information that indicates positions of a plurality of ships at each point of time, with reference to the AIS accumulation data 30. Although a case where the AIS accumulation data 30 and the sailing route information 31 are stored in the storage unit 24 of the sea area information generation device 20 will be described in the present embodiment, the AIS accumulation data 30 and the sailing route information 31 may be stored in an external storage device such as a “storage” device. In such a case, the acquisition unit 41 acquires the sailing route information 31 and positional information that indicates positions of a plurality of ships at each point of time from such an external storage device.

The generation unit 42 generates closest distance information for each sea area corresponding to positions of closest approach of two ships, from the positional information and the sailing route information, the closest distance information including a statistical quantity of a distance of closest approach between the two ships, the statistical quantity of a distance of closest approach being calculated based on encountering relationship for directions of the two ships and whether or not ship tracks of the two ships are along a sailing route in the sea area. For example, the generation unit 42 obtains, for each combination of two ships, a distance of closest approach where two ships are closest to one another, a date and time when the distance of closest approach is provided, and positions of the two ships provided at the distance of closest approach, by using positional information that indicates positions of a plurality of ships at each point of time, as acquired by the acquisition unit 41. For example, the generation unit 42 obtains a distance between two ships in order of time series, for each combination of two ships, with respect to respective ships that exist at an identical point of time, and thereby, identifies a distance of closest approach where two ships are closest to one another, a date and time when the distance of closest approach is provided, and positions of the two ships provided at the distance of closest approach.

The generation unit 42 also obtains traveling directions of two ships at a predetermined point of time while a date and time when a distance of closest approach is provided are a reference thereof. Such a predetermined point of time may be a date and time when a distance of closest approach is provided or may be a predetermined time (for example, 5 minutes) before a date and time when a distance of closest approach is provided. For such a traveling direction, a bow direction in AIS information may be used or the traveling direction may be obtained from a ship track of a position of a ship before and after a predetermined point of time.

The generation unit 42 stores a distance of closest approach between and traveling directions of two ships, MMSI numbers of the ships, and the like, as the closest approach information 32. In a case where a distance of closest approach is sufficiently large, there is no risk of collision. Hence, the generation unit 42 stores each piece of information for only two ships with a distance of closest approach being provided within a predetermined distance (for example, 1 km) for determining a risk of collision, as the closest approach information 32.

The generation unit 42 identifies an encounter relationship between two ships, for each combination of two ships stored as the closest approach information 32. For example, the generation unit 42 obtains, for two ships stored in the closest approach information 32, an angle of a traveling direction of one ship among two ships with reference to a traveling direction of the other ship. FIG. 5 is a diagram illustrating an angle between ships. For example, a ship 11A travels in a direction of 90° with reference to the north. A ship 11B travels in a direction of 60° with reference to the north. In such a case, an angle θ of a traveling direction of the ship 11B with reference to a traveling direction of the ship 11A is −30 degrees.

The generation unit 42 identifies an encounter relationship between two ships based on an angle θ between the two ships. For example, the generation unit 42 identifies a following or passing relationship in a case where the angle θ is within ±67.5 degrees. The generation unit 42 identifies a crossing relationship in a case where the angle θ is over ±67.5 degrees and within ±112.5 degrees. The generation unit 42 identifies a facing relationship within a range from ±112.5 degrees to ±180 degrees. The range as described above is an example and this is not limiting. An encounter relationship between two ships may be identified from positional relationship between two ships. For example, the generation unit 42 may identify an encounter relationship between two ships while a law or regulation such as the Act for Preventing Collisions at Sea is a criterion for determination.

The generation unit 42 obtains the number of occurrences of each of a facing relationship, a following or passing relationship, and a crossing relationship, for each sea area provided by dividing a target range that is a target for control of sailing for the onshore facility 13. For example, in a case where two ships are positioned in an identical sea area when being provided at a distance of closest approach, the generation unit 42 counts the number of occurrences of each of a facing relationship, a following or passing relationship, and a crossing relationship in the sea area. On the other hand, in a case where two ships are positioned in different sea areas when being provided at a distance of closest approach, the generation unit 42 counts the number of occurrences of each of a facing relationship, a following or passing relationship, and a crossing relationship in a sea area with a middle point between positions of the two ships being positioned therein.

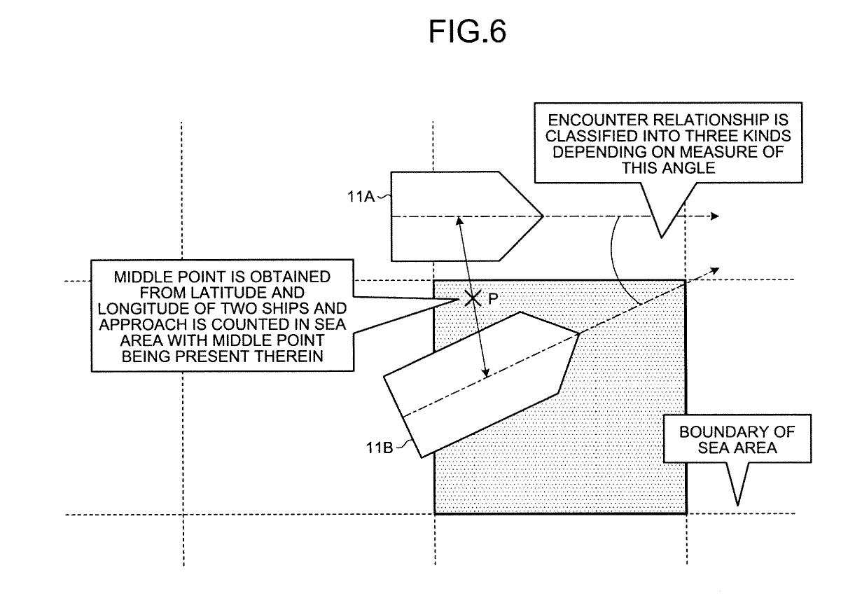

FIG. 6 is a diagram illustrating a case where two ships are positioned in different sea areas. In an example of FIG. 6, each sea area is indicated by broken lines. A ship 11A and a ship 11B are positioned in different sea areas. In such a case, the generation unit 42 obtains a middle point P from latitude and longitude of each of the two ships 11A and 11B and counts the number of occurrences of each of a facing relationship, a following or passing relationship, and a crossing relationship in a sea area with the middle point P being positioned therein.

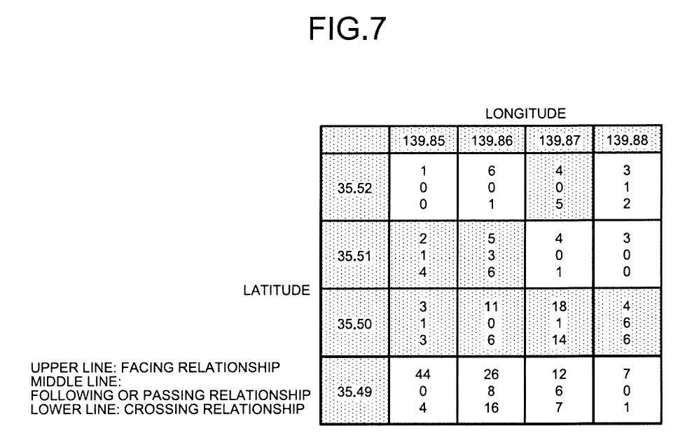

FIG. 7 is a diagram illustrating an example of a result of counting of the number of occurrences for each sear area. In FIG. 7, latitude of a position of an upper left vertex of a sea area is illustrated on a left side thereof and longitude of a position of an upper left vertex of a sea area is illustrated on a top thereof. FIG. 7 also illustrates, for each sea area, the number of occurrences of a facing relationship on an upper line, the number of occurrences of a following or passing relationship on a middle line, and the number of occurrences of a crossing relationship on a lower line.

The generation unit 42 stores the number of occurrences of each pattern of an encounter relationship for each sea area provided by dividing a target range as the positional relationship information 33.

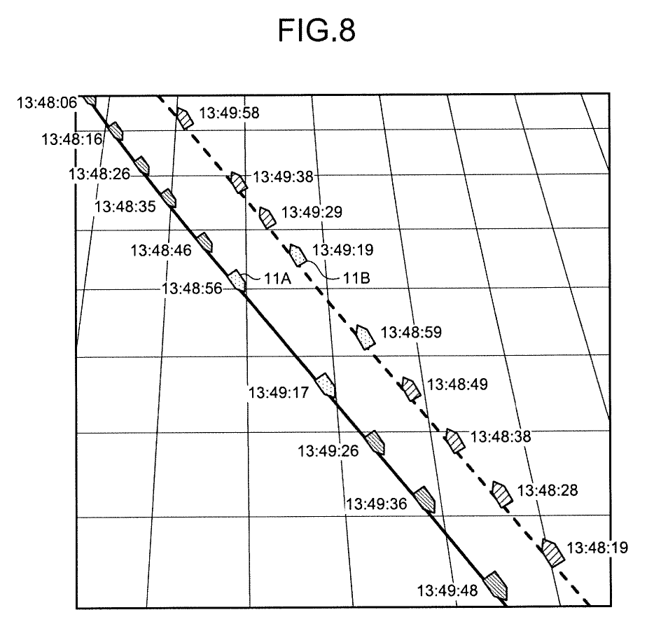

Herein, a factor that is to be taken into consideration for safety of a ship is not only a relationship between ships but also may be a geographical factor that acts thereon, and as determination of abnormal closeness is executed by only a relationship between ships, there is a possibility of causing erroneous detection. FIG. 8 is a diagram illustrating ship tracks of two ships 11A and 11B that travel along a sailing route thereof. The ships 11A and 11B with ship tracks illustrated in FIG. 8 are such that a distance of closest approach therebetween is approximately 50 m whereas lengths of the ships are approximately 70 m, and hence, seem to be fairly close to one another, but avoidance behavior is not yet taken on so that it is not considered dangerous. On a main sailing route, even in a narrow space, straight traveling is executed in many cases, and hence, a surrounding ship has a low risk.

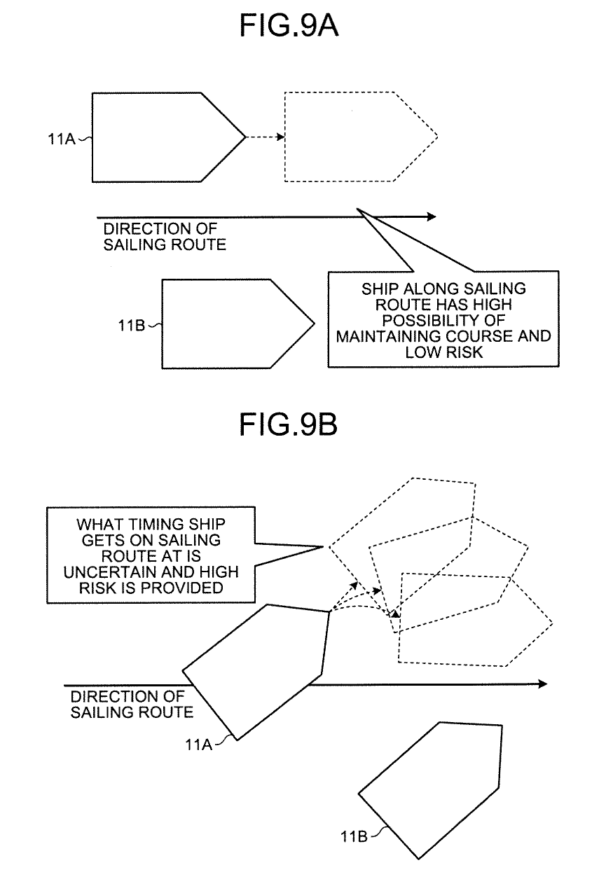

In general, in a case where a ship sails along a sailing route thereof, the ship has a high tendency to continue to travel along the sailing route. FIG. 9A and FIG. 9B are diagrams illustrating tendencies of sailing of ships. FIG. 9A illustrates a tendency of sailing in a case where ships 11A and 11B sail along a sailing route thereof. FIG. 9B illustrates a tendency of sailing in a case where ships 11A and 11B do not sail along a sailing route thereof. As illustrated in FIG. 9A, in a case where the ships 11A and 11B sail along a sailing route thereof, there is a high possibility of maintaining courses thereof. On the other hand, as illustrated in FIG. 9B, in a case where the ships 11A and 11B do not sail along the sailing route, it is uncertain what timing the ships get on the sailing route at and it is not possible to know where courses thereof are changed, so that a surrounding ship has a high risk. In an example of FIG. 9B, the ship 11A turns a bow thereof to the right.

However, even in a case where a sailing route is set, there is a sea area with a lot of ships that cross a sailing route thereof or ships that depart from a sailing route thereof. It is need for attention to such a sea area even in a case where a ship along a sailing route thereof is provided.

In such a situation, the generation unit 42 calculates a rate of occurrence of a crossing relationship, from the number of occurrences of each pattern of an encounter relationship for each sea area provided by dividing a target range that is stored as the positional relationship information 33. The generation unit 42 extracts a sea area with a crossing relationship being less frequent from a rate of occurrence of the crossing relationship for each sea area. For example, the generation unit 42 adds, for each sea area, the number of occurrences of a facing relationship, the number of occurrences of a following or passing relationship, and the number of occurrences of a crossing relationship, and obtains a rate of the number of occurrences of a crossing relationship to a sum of the numbers of occurrences. The generation unit 42 obtains a sea area with a crossing relationship being less frequent where a rate of the number of occurrences of the crossing relationship is less than or equal to a predetermined reference. Such a predetermined reference is, for example, ⅓, and is not limited thereto. A predetermined reference may be changeable externally. For example, a screen for setting a predetermined reference may be displayed on the display unit 23 to be changeable by input from the input unit 22. In an example of FIG. 7, for example, a predetermined reference is ⅓, and a pattern is provided to a sea area with a crossing relationship being more frequent where a rate of the number of occurrences of the crossing relationship is not less than or equal to ⅓. For example, a sea area provided with no pattern is a sea area with a crossing relationship being less frequent. A sea area provided with a pattern is a sea area with a crossing relationship being more frequent.

The generation unit 42 generates, for each sea area, a statistic of a distance of closest approach from all ship tracks in the sea area. For example, the generation unit 42 calculates an average of distances of closest approach for all combinations of two ships, as a statistic of a distance of closest approach. Hereinafter, an average of distances of closest approach for all combinations of two ships will also be described as an average of distances of closest approach between all ships.

The generation unit 42 determines whether ship tracks of two ships that are provided in a facing relationship or a following or passing relationship are along a sailing route thereof, for a sea area with a crossing relationship being less frequent where a rate of the number of occurrences of the crossing relationship is less than or equal to a predetermined reference. The generation unit 42 generates each statistic of a distance of closest approach between ship tracks along a sailing route. For example, the generation unit 42 identifies a direction of a sailing route for a sea area with a crossing relationship being less frequent. In a case where information of such a direction is included in the sailing route information 31, the generation unit 42 may identify a direction of a sailing route in a sea area from the sailing route information 31 acquired by the acquisition unit 41. The generation unit 42 may identify a direction of a sailing route in a sea area from positional information that indicates positions of a plurality of ships at each point of time as acquired by the acquisition unit 41. For example, the generation unit 42 extracts positional information of two ships that are provided in a facing relationship or a following or passing relationship in a sea area. In a case where a traveling direction of a ship is greater than 180 degrees, the generation unit 42 executes rotation thereof by 180 degrees. Thereby, a traveling direction of each ship is provided within a range of 0 to 180 degrees with reference to the north.

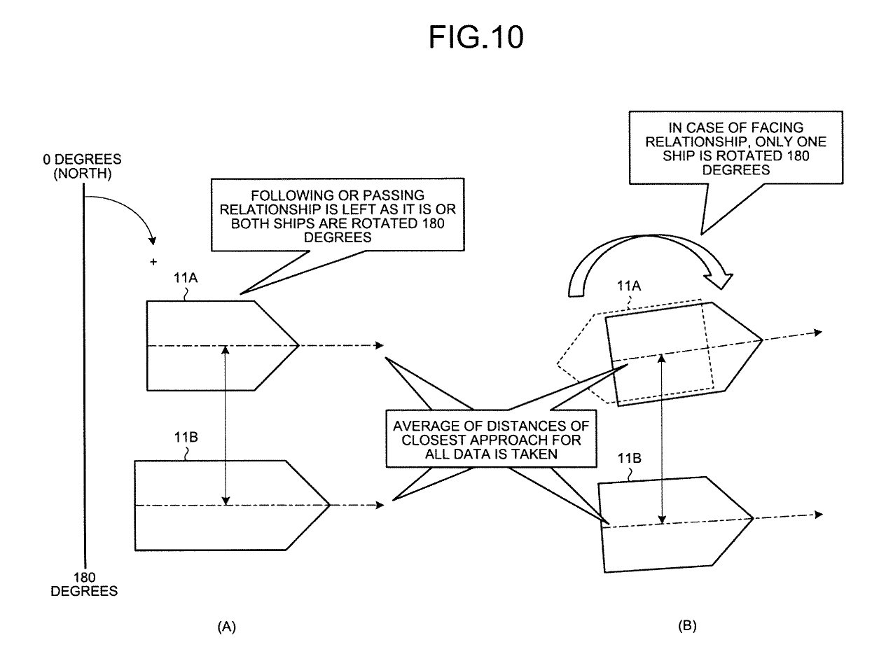

FIG. 10 is a diagram illustrating an example of a traveling direction. In an example of FIG. 10 (A), ships 11A and 11B are provided in a following or passing relationship. In an example of FIG. 10 (B), ships 11A and 11B are provided in a facing relationship. The generation unit 42 rotates a traveling direction of a ship by 180 degrees in a case where the traveling direction is greater than 180 degrees, and leaves a traveling direction of a ship as it is in a case where the traveling direction is not greater than 180 degrees. In an example of FIG. 10 (A), traveling directions of the ships 11A and 11B are less than or equal to 180 degrees, and hence, the traveling directions are left as they are. In an example of FIG. 10 (B), a traveling direction of the ship 11A is greater than 180 degrees, and hence, the traveling direction is rotated by 180 degrees.

The generation unit 42 compares, for a sea area with a crossing relationship being less frequent, a ship track that is provided in a facing relationship or a following or passing relationship and a direction of a sailing route, and determines that the ship track is along the sailing route. For example, the generation unit 42 compares a ship track and a direction of a sailing route at a position corresponding to a distance of closest approach, and determines that the ship track is along the sailing route in a case where an angle between the ship track and the direction of the sailing route is less than or equal to a predetermined reference angle. Such a predetermined reference angle is, for example, 5 degrees and is not limited thereto. A predetermined reference angle may be changeable externally. For example, a screen for setting a predetermined reference angle may be displayed on the display unit 23 to be changeable by input from the input unit 22. The generation unit 42 determines that ship tracks of two ships are along a sailing route thereof in a case where both of the two ships have the ship tracks along the sailing route. The generation unit 42 may determine that ship tracks of two ships are along a sailing route thereof in a case where a ship track of one ship among the two ships is along the sailing route.

The generation unit 42 generates a statistic of a distance of closest approach between ship tracks along a sailing route, for a sea area with a crossing relationship being less frequent. For example, the generation unit 42 calculates, as a statistic of a distance of closest approach, an average of distances of closest approach between two ships with ship tracks determined to be along a sailing route thereof. Hereinafter, such an average of distances of closest approach between two ships with ship tracks determined to be along a sailing route thereof will also be represented by an average of distances of closest approach between ships along a sailing route thereof.

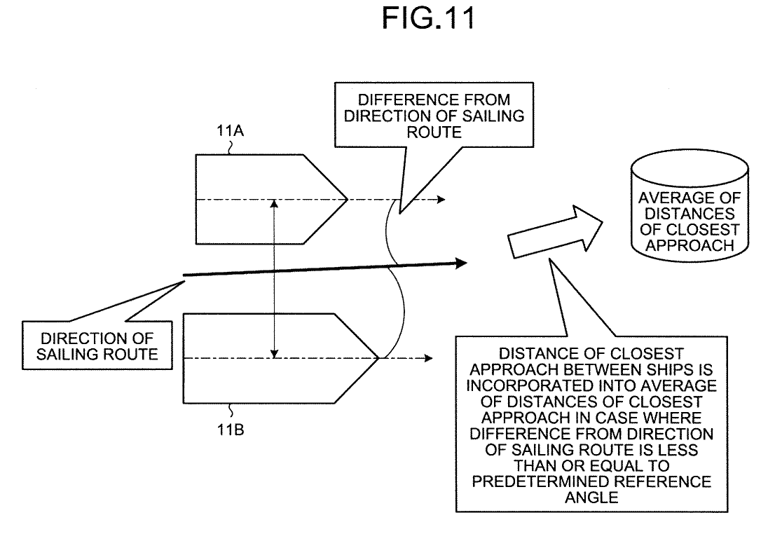

FIG. 11 is a diagram illustrating an example of a difference between a ship track of a ship and a direction of a sailing route thereof. The generation unit 42 compares ship tracks of ships 11A and 11B with a direction of a sailing route thereof, and incorporates a distance of closest approach between the ships 11A and 11B into a target for calculation of an average of distances of closest approach in a case where a difference from the direction of a sailing route is less than or equal to a predetermined reference angle.

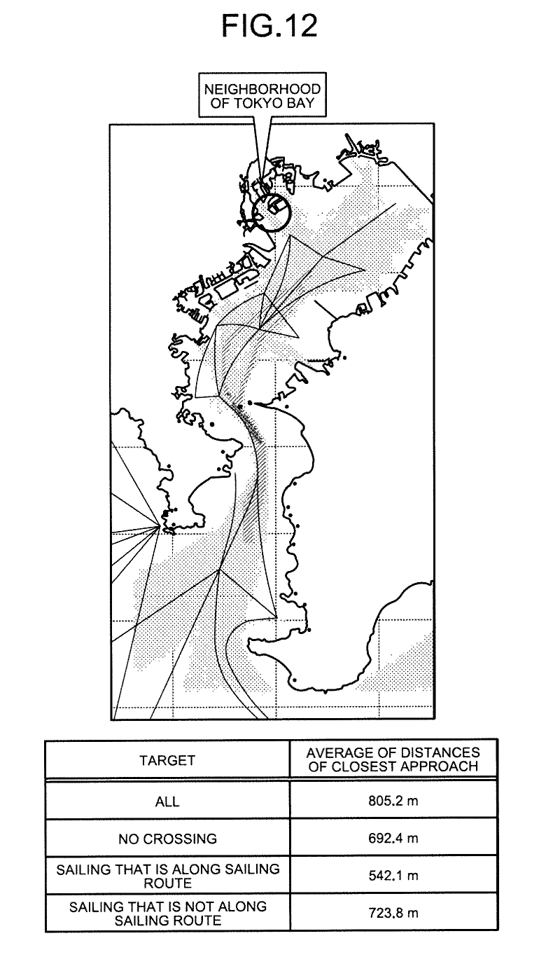

Herein, an example of a calculated average of distances of closest approach will be described. FIG. 12 is a diagram illustrating an example of an average of distances of closest approach. An example of FIG. 12 illustrates an obtained average of distances of closest approach for neighborhood of Tokyo Bay. A risk of approach also depends on a size of a ship. In an example of FIG. 12, an average of distances of closest approach is calculated, in particular, for a large ship with a high risk (for example, a ship length greater than or equal to 100 m). “ALL” is a result of an obtained average of distances of closest approach for respective combinations of two ships with respect to all ships that sail in a sea area (all of a facing relationship, a following or passing relationship, and a crossing relation-hip). “NO CROSSING” is a result of an obtained average of distances of closest approach between two ships that are provided in a facing relationship or a following or passing relationship except a crossing relationship. “TRAVELING THAT IS ALONG SAILING ROUTE” is a result of an obtained average of distances of closest approach between two ships with ship tracks along a sailing route thereof, for two ships that are provided in a facing relationship or a following or passing relationship except a crossing relationship. That is, “TRAVELING THAT IS ALONG SAILING ROUTE” is a result of an obtained average of distances of closest approach between two ships with ship tracks along a sailing route thereof, for two ships that are provided as targets for “NO CROSSING”. “TRAVELING THAT IS NOT ALONG SAILING ROUTE” is a result of an obtained average of distances of closest approach between two ships with ship tracks not being along a sailing route thereof, for two ships that are provided in a facing relationship or a following or passing relationship except a crossing relationship. That is, “TRAVELING THAT IS NOT ALONG SAILING ROUTE” is a result of obtained average of distances of closest approach between two ships with ship tracks not being along a sailing route thereof, for two ships that are provided as targets for “NO CROSSING”. The generation unit 42 calculates, for each sea area, an average of distances of closest approach between all ships that correspond to “ALL” in FIG. 12. The generation unit 42 also calculates, for each sea area with a crossing relationship being less frequent, an average of distances of closest approach between ships along a sailing route that corresponds to “TRAVELING THAT IS ALONG SAILING ROUTE” in FIG. 12.

The generation unit 42 stores, for each sea area provided by dividing a target range, a generated statistic of a distance of closest approach, as the statistic information 34. For example, the generation unit 42 stores, for each sea area, an average of distances of closest approach between all ships, as the statistic information 34. The generation unit 42 also stores, for each sea area with a crossing relationship being less frequent, an average of distances of closest approach between ships along a sailing route thereof, as the statistic information 34.

The determination unit 43 determines whether a risk of collision is high, by using the statistic information 34. For example, the determination unit 43 obtains, for each sea area, a reference distance for determining approach with a high risk of collision, from an average of distances of closest approach stored as the statistic information 34. For example, the determination unit 43 multiplies an average of distances of closest approach by a predetermined safety factor to obtain a reference distance. For example, the determination unit 43 multiplies, for each sea area, average of distances of closest approach between all ships by a safety factor to obtain a reference distance for all ships. The determination unit 43 multiplies, for each sea area with a crossing relationship being less frequent, an average of distances of closest approach between ships along a sailing route thereof by a safety factor to obtain a reference distance for the ships along the sailing route. Such a safety factor is, for example, 1.0 and is not limited thereto. A safety factor may be, for example, 1.5 in a safety sensitive case, or may be, for example, 0.8 in a case where warning is provided only in a risky case. A safety factor may be changeable externally. For example, a screen for setting a safety factor may be displayed on the display unit 23 to be changeable by input from the input unit 22. A safety factor may be changed depending on a kind or a size of a ship that is a target for determining a risk of collision. For example, in a case where one of two ships is a ship with a package with a high risk being loaded thereon, a safety factor may be changed to a large value. Whether a package has a high risk can be determined from, for example, sailing-related information that is included in AIS information. For example, as a length of a ship is increased, a safety factor may be changed to a larger value.

The determination unit 43 reads positions of respective ships that exist at an identical point of time, from the AIS accumulation data 30 in order of time series, and obtains a distance between two ships for each combination of two ships. The determination unit 43 also identifies a sea area with two ships being positioned therein. For example, in a case where two ships are positioned in an identical sea area, the determination unit 43 identifies the sea area as a sea area with the two ships being positioned therein. On the other hand, in a case where two ships are positioned in different sea areas, the determination unit 43 obtains a middle point from latitude and longitude of each of the two ships, and identifies a sea area with the middle point being position therein, as a sea area with the two ships being positioned therein.

The determination unit 43 determines a risk of collision from a distance between two ships by using a reference distance for each identified sea area.

For example, in a case where a sea area is a sea area with a crossing relationship being less frequent, the determination unit 43 determines whether ship tracks of two ships are along a sailing route thereof. For example, the determination unit 43 compares each of ship tracks of two ships with a direction of a sailing route thereof, and determines that a ship track is along the sailing route in a case where an angle between the ship track and a direction of the sailing route is less than or equal to a predetermined reference angle as described above. In a case where both of two ships have ship tracks along a sailing route thereof, the determination unit 43 determines that the ship tracks of the two ships are along the sailing route. In a case where a ship track of one ship among two ships is along a sailing route thereof, the determination unit 43 may determine that ship tracks of the two ships are along the sailing route. In a case where ship tracks of two ships are along a sailing route thereof, the determination unit 43 determines whether a distance between the two ships is less than or equal to a reference distance of a ship along the sailing route. In a case where a distance between two ships is less than or equal to a reference distance of a ship along a sailing route thereof, the determination unit 43 determines approach with a high risk of collision therebetween. In a case where ship tracks of two ships are not along a sailing route thereof, the determination unit 43 determines whether a distance between the two ships is less than or equal to a reference distance for all ships. In a case where a distance between two ships is less than or equal to a reference distance for all ships, the determination unit 43 determines that a risk of collision therebetween is high.

For example, in a case where a sea area is a sea area with a crossing relationship being more frequent, the determination unit 43 determines whether a distance between two ships is less than or equal to a reference distance for all ships. In a case where a distance between two ships is less than or equal to a reference distance for all ships, the determination unit 43 determines that a risk of collision therebetween is high.

The output unit 44 executes a variety of output. For example, the output unit 44 outputs a variety of information on approach that is determined to have a high risk of collision by the determination unit 43. For example, the output unit 44 outputs information such as a sea area where approach with a high risk of collision is caused, or positions of two ships, to a file, a screen, or an external device. Thereby, a sea area where approach with a high risk of collision is caused or the like can be identified.

A case where the determination unit 43 identifies, from the AIS accumulation data 30, a sea area where approach with a high risk of collision was caused in a past has been described, and this is not limiting. The determination unit 43 may determine approach between ships with a high risk of collision, from positional information of a ship at current point of time that is accumulated as the AIS accumulation data 30 as needed. The output unit 44 may output warning indicating that there is a risk of collision, to ships with a high risk of collision therebetween.

The output unit 44 may transmit a reference distance for each sea area to the AIS device 12 of each ship and the AIS device 12 of each ship may determine a risk of collision by using the reference distance for each sea area.

Flow of Process

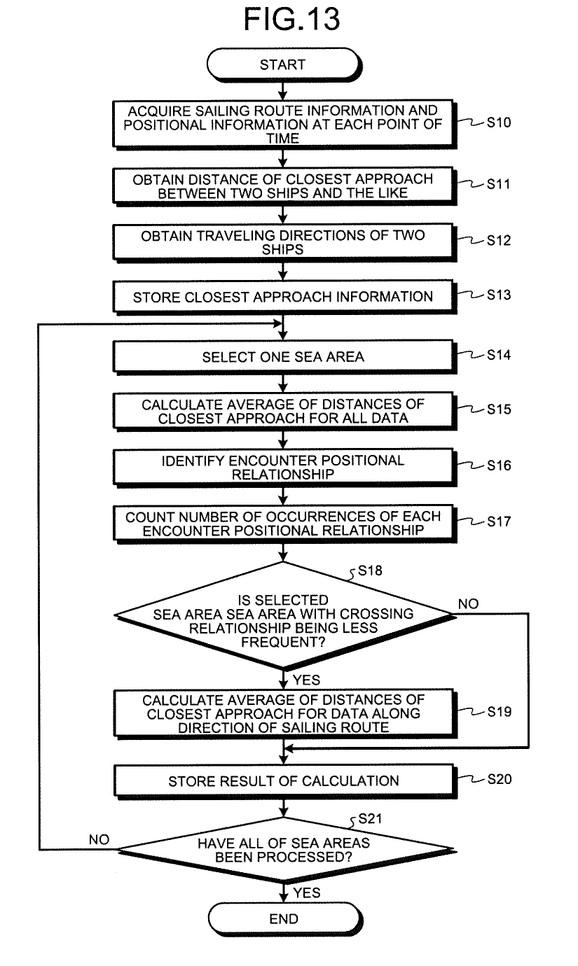

Next, a flow of a sea area information generation process of the sea area information generation device 20 according to the present embodiment to generate a statistic of a distance of closest approach for each sea area in a target range that is a target for control of sailing for the onshore facility 13 will be described. FIG. 13 is a flowchart illustrating an example of steps of a sea area information generation process. Such a sea area information generation process is executed at predetermined timing, for example, timing when a predetermined operation for instructing a start of the process is accepted.

As illustrated in FIG. 13, the acquisition unit 41 acquires the sailing route information 31 and positional information that indicates positions of a plurality of ships at each point of time (Step S10). For example, the acquisition unit 41 acquires, with reference to the sailing route information 31, information of a position of a boundary of a sailing route that exists in a target range that is a target for control of sailing for the onshore facility 13, and in a case where a direction of a sailing route is set, information of the direction. The acquisition unit 41 also acquires, with reference to the AIS accumulation data 30, positional information that indicates positions of a plurality of ships at each point of time.

The generation unit 42 obtains, for each combination of two ships, a distance of closest approach where two ships are closest to one another, a date and time when the distance of closest approach is provided, and positions of the two ships provided at the distance of closest approach, by using the positional information that indicates positions of a plurality of ships at each point of time, as acquired by the acquisition unit 41 (Step S11). The generation unit 42 also obtains traveling directions of two ships for each combination of two ships (Step S12). The generation unit 42 stores, the distance of closest approach between and the traveling directions of two ships, MMSI numbers of the ships, and the like, as the closest approach information 32 (Step S13).

The generation unit 42 selects one unselected sea area among sea areas provided by dividing a target range (Step S14). The generation unit 42 calculates an average of distances of closest approach between any two ships provided at a distance of closest approach in the selected sea area (Step S15).

The generation unit 42 identifies an encounter relationship between two ships, for two ships provided at a distance of closest approach in the selected sea area (Step S16). The generation unit 42 obtains the number of occurrences of each encounter relationship for the selected sea area and obtains a rate of the number of occurrences of a crossing relationship (Step S17).

The generation unit 42 determines whether the selected area is a sea area with a crossing relationship being less frequent where a rate of the number of occurrences of a crossing relationship is less than or equal to a predetermined reference (Step S18). In a case where the selected sea area is not a sea area with a crossing relationship being less frequent (Step S18, No), the process goes to Step S20 as described later.

On the other hand, in a case where the selected sea area is a sea area with a crossing relationship being less frequent (Step S18, Yes), the generation unit 42 generates an average of distances of closest approach between ship tracks along a sailing route, among ship tracks with two ships being provided in a facing relationship or a following or passing relationship, for a sea area with a crossing relationship being less frequent (Step S19).

The generation unit 42 stores such a generated statistic of a distance of closest approach for the selected sea area as the statistic information 34 (Step S20).

The generation unit 42 determines whether or not all of the sea areas provided by dividing a target range have been selected (Step S21). In a case where not all of the sea areas have been selected (Step S21, No), the process goes to Step S14 as described above.

On the other hand, in a case where all of the sea areas have been selected (Step S21, Yes), the process is ended.

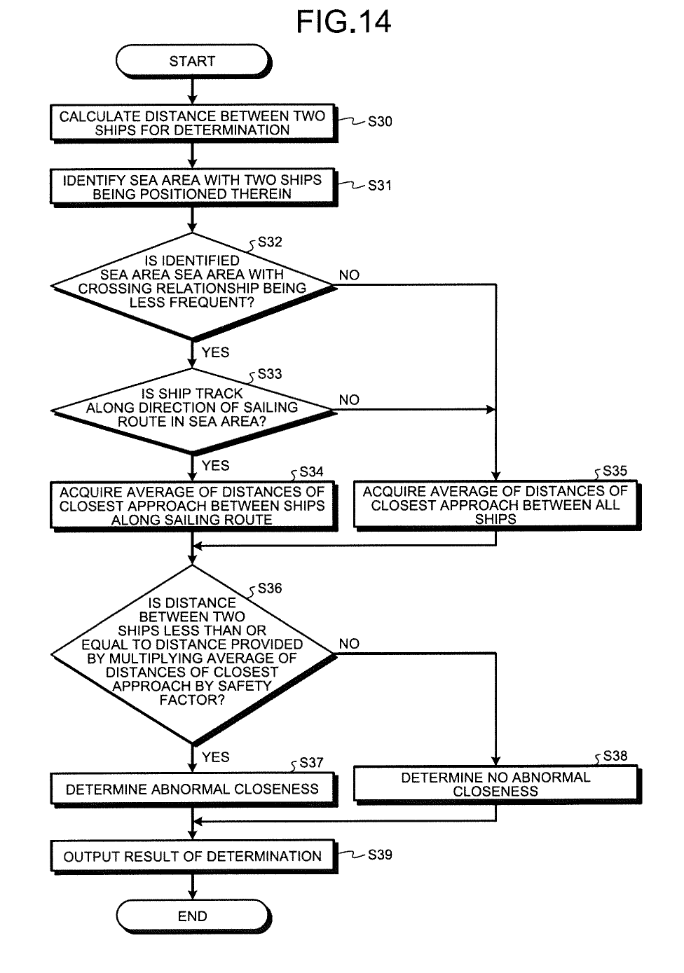

Next, a flow of an approach determination process of the sea area information generation device 20 according to the present embodiment to determine approach with a high risk of collision will be described. FIG. 14 is a flowchart illustrating an example of steps of an approach determination process. Such an approach determination process is executed at predetermined timing, for example, timing when a predetermined operation for specifying two ships that are provided as targets for determination and instructing a start of the process is accepted.

As illustrated in FIG. 14, the determination unit 43 obtains a distance between two ships that are provided as targets for determination, from the AIS accumulation data 30 (Step S30). The determination unit 43 identifies a sea area with the two ships being positioned therein (Step S31). The determination unit 43 determines whether the identified sea area is a sea area with a crossing relationship being less frequent (Step S32). In a case where the identified sea area is not a sea area with a crossing relationship being less frequent (Step S32, No), the process goes to Step S35 as described later.

On the other hand, in a case where the identified sea area is a sea area with a crossing relationship being less frequent (Step S32, Yes), the determination unit 43 determines whether ship tracks of the two ships are along a sailing route thereof (Step S33). In a case where ship tracks of the two ships are along a sailing route thereof (Step S33, Yes), the determination unit 43 acquires an average of distances of closest approach between ships along a sailing route in the identified sea area, from the statistic information 34 (Step S34).

On the other hand, in a case where ship tracks of the two ships are not along a sailing route thereof (Step S33, No), the determination unit 43 acquires an average of distances of closest approach between all ships in the identified sea area, from the statistic information 34 (Step S35). Also in a case where the identified sea area is not a sea area with a crossing relationship being less frequent (Step S32, No), the determination unit 43 acquires an average of distances of closest approach between all ships in the identified sea area, from the statistic information 34 (Step S35).

The determination unit 43 multiplies the acquired average of distances of closest approach by a safety factor to obtain a reference distance and determines whether a distance between the two ships is less than or equal to the reference distance (Step S36). In a case where a distance between the two ships is less than or equal to the reference distance (Step S36, Yes), the determination unit 43 determines abnormal closeness with a high risk of collision therebetween (Step S37). On the other hand, in a case where a distance between the two ships is greater than the reference distance (Step S36, Yes), no abnormal closeness is determined (Step S38).

The output unit 44 outputs a variety of information on approach that is determined to have a high risk of collision by the determination unit 43 (Step S39) and ends the process.

### Advantageous Effect

The sea area information generation device 20 according to the present embodiment acquires sailing route information and positional information that indicates positions of a plurality of ships at each point of time. The sea area information generation device 20 generates, for each sea area corresponding to positions of closest approach of two ships, a statistic of a distance of closest approach dependent on an encounter relationship between the two ships and whether or not ship tracks thereof are along a sailing route thereof, with reference to the sailing route information and the positional information. The sea area information generation device 20 determines a risk of collision by using the generated statistic of a distance of closest approach for each sea area, and thereby, can determine approach with a high risk of collision.

Furthermore, the sea area information generation device 20 according to the present embodiment obtains, for each sea area, the number of occurrences of each of a facing relationship, a following or passing relationship, and a crossing relationship, while the encounter relationship between the two ships is classified into the facing relationship, the following or passing relationship, and the crossing relationship. The sea area information generation device 20 determines whether ship tracks of the two ships that are provided in the facing relation or the following or passing relationship are along the sailing route in a sea area with a rate of the number of occurrences of the crossing relationship being less than or equal to a predetermined reference to generate a statistic of a distance of closest approach between ship tracks along the sailing route. The sea area information generation device 20 determines, for a sea area with a rate of the number of occurrences of a crossing relationship being less than or equal to a predetermined reference and a ship with a ship track being along a sailing route, a risk of collision by using the generated statistic of a distance of closest approach, and thereby, can appropriately determine approach with a high risk of collision.

Furthermore, the sea area information generation device 20 according to the present embodiment determines that ship tracks of the two ships are along the sailing route in a case where both of the two ships have ship tracks along the sailing route. Thereby, the sea area information generation device 20 can accurately determine a ship with a high possibility of maintaining a course thereof.

Although the embodiment for a disclosed device has been described above, a disclosed technique may be implemented in a variety of different modes as well as the embodiment described above. Hereinafter, other embodiments that are included in the present invention will be described.

For example, although a case where an average of distances of closest approach is generated as a statistic of a distance of closest approach has been described as an example in the embodiment described above, a disclosed device is not limited thereto. For example, a minimum or a dispersion of distances of closest approach may be generated as a statistic of a distance of closest approach. For example, a minimum of distances of closest approach may be multiplied by a safety factor (for example, two) to provide a reference distance.

Although a case where an average of distances of closest approach between ships that are along a sailing route thereof is obtained for a sea area with a crossing relationship being less frequent has been described as an example in the embodiment described above, a disclosed device is not limited thereto. For example, the generation unit 42 obtains, and stores as the statistic information 34, an average of distances of closest approach between ships that are not along a sailing route thereof, for a sea area with a crossing relationship being less frequent. In a case of a sea area with a crossing relationship being less frequent, the determination unit 43 determines whether ship tracks of two ships are along a sailing route thereof. For two ships that are not along a sailing route thereof, the determination unit 43 may determine approach with a high risk of collision depending on whether it is less than or equal to a reference distance provided by multiplying an average of distances of closest approach between ships that are not along a sailing route thereof by a safety factor.

Although a case where information on a sailing route is acquired from the sailing route information 31 that has been stored preliminarily has been described as an example in the embodiment described above, a disclosed device is not limited thereto. For example, sailing route information may be acquired by being generated from positional information of a sailing ship. For example, in a case where a direction of a ship track of a ship that has passed through a specific region of a sea area is provided at a predetermined rate (for example, 70%) or greater, the acquisition unit 41 may regard the direction of a ship track as a sailing route and generate sailing route information to acquire the sailing route information.

Each component of each device as illustrated in the drawings is functionally conceptual and need not be physically configured as illustrated in the drawings. That is, a specific state of separation or integration of respective devices is not limited to that illustrated in the drawings, and all or a part thereof can be configured to be functionally or physically separated or integrated in an arbitrary unit depending on a variety of loads, usage, or the like. For example, respective processing units that are the storing unit 40, the acquisition unit 41, the generation unit 42, the determination unit 43, and the output unit 44 may be integrated or separated appropriately. All or any part of respective processing functions that are executed in respective processing units can be realized by a CPU and a program that is analyzed and executed in the CPU or realized by hardware based on a wired logic.

Sea Area Information Generation Program

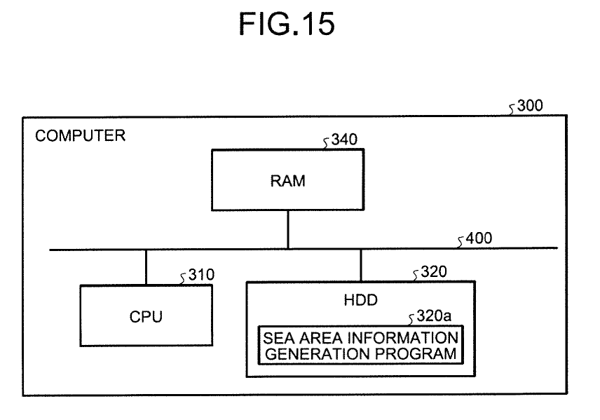

A variety of processes as described in the embodiment as described above can also be realized by executing a preliminarily prepared program in a computer system such as a personal computer or a workstation. Hereinafter, an example of a computer system will be described that executes a program that has a function similar to that of the embodiment as described above. FIG. 15 is a diagram illustrating a computer that executes a sea area information generation program.

As illustrated in FIG. 15, a computer 300 includes a CPU 310, a Hard Disk Drive (HDD) 320, and a Random Access Memory (RAM) 340. Respective units 310 to 340 are connected to one another through a bus 400.

A sea area information generation program 320a that fulfills a function similar to that of each processing unit in the embodiment as described above is preliminarily stored in the HDD 320. For example, the sea area information generation program 320a is stored that fulfills functions similar to those of the storing unit 40, the acquisition unit 41, the generation unit 42, the determination unit 43, and the output unit 44 in the embodiment as described above. The sea area information generation program 320a may be divided appropriately.

The HDD 320 stores a variety of data. For example, the HDD 320 stores an OS and a variety of data.

The CPU 310 reads from the HDD 320 and execute the sea area information generation program 320a, and thereby, executes an operation similar to that of each processing unit in the embodiment. That is, the sea area information generation program 320a executes operations similar to those of the storing unit 40, the acquisition unit 41, the generation unit 42, the determination unit 43, and the output unit 44 in the embodiment.

The sea area information generation program 320a as described above need not be stored in the HDD 320 from a start. For example, a program is stored in a “portable physical medium” that is inserted into the computer 300, such as a flexible disk (FD), a Compact Disk Read Only Memory (CD-ROM), a Digital Versatile Disk (DVD), a magneto optical disk, or an IC card. The computer 300 may read therefrom and execute a program.

A program is stored in “another computer (or server)” or the like that is connected to the computer 300 through a public line, the internet, a LAN, a WAN, or the like. The computer 300 may read therefrom and execute a program.

According to an embodiment of the present invention, an advantageous effect is provided such that approach with a high risk of collision can be determined.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a generation program that causes a computer to execute a process comprising:
acquiring positional information including positions of a plurality of ships at a plurality of timings;
acquiring, or generating from the positional information, sailing route information of the plurality of ships; and
generating closest distance information for each sea area corresponding to positions of closest approach of two ships, from the positional information and the sailing route information, the closest distance information including a statistical quantity of a distance of closest approach between the two ships, the statistical quantity of a distance of closest approach being calculated based on encountering relationship for directions of the two ships and whether or not ship tracks of the two ships are along a sailing route in the sea area.

2. The non-transitory computer-readable recording medium according to claim 1, wherein the generating includes:
obtaining, for each sea area, a number of occurrences of each of a facing relationship, a following or passing relationship, and a crossing relationship, while the encounter relationship between the two ships is classified into the facing relationship, the following or passing relationship, and the crossing relationship; and
determining whether ship tracks of the two ships that are provided in the facing relationship or the following or passing relationship are along the sailing route in a sea area with a rate of a number of occurrences of the crossing relationship being less than or equal to a predetermined reference to generate the closest distance information along the sailing route.

3. The non-transitory computer-readable recording medium according to claim 2, wherein the generating includes determining that ship tracks of the two ships are along the sailing route in a case where both of the two ships have ship tracks along the sailing route.

4. A sea area information generation method comprising:
acquiring, by a processor, positional information including positions of a plurality of ships at a plurality of timings;
acquiring, or generating from the positional information, sailing route information of the plurality of ships by the processor; and
generating, by the processor, closest distance information for each sea area corresponding to positions of closest approach of two ships from the positional information and the sailing route information, the closest distance information including a statistical quantity of a distance of closest approach between the two ships, the statistical quantity of a distance of closest approach being calculated based on encountering relationship for directions of the two ships and whether or not ship tracks of the two ships are along a sailing route in the sea area.

5. A sea area information generation device comprising: a processor that executes a process, the process comprising:
acquiring positional information including positions of a plurality of ships at a plurality of timings;
acquiring, or generating from the positional information, sailing route information of the plurality of ships; and
generating closest distance information for each sea area corresponding to positions of closest approach of two ships, from the positional information and the sailing route information, the closest distance information including a statistical quantity of a distance of closest approach between the two ships, the statistical quantity of a distance of closest approach being calculated based on encountering relationship for directions of the two ships and whether or not ship tracks of the two ships are along a sailing route in the sea area.
